(19) United States
(12) Patent Application Publication
(10) Pub. No.: US 2023/0375898 A1
(43) Pub. Date: Nov. 23, 2023

(54) CAMERA

(71) Applicant: NIDEC PRECISION CORPORATION, Tokyo (JP)

(72) Inventor: Yuichiro USUDA, Tokyo (JP)

(21) Appl. No.: 18/318,722

(22) Filed: May 17, 2023

(30) Foreign Application Priority Data
May 20, 2022 (JP) 2022-082980

(51) Int. Cl. G03B 9/10; G03B 5/00; H02K 41/035

(52) U.S. Cl. CPC G03B 9/10; G03B 5/00; H02K 41/0354; G03B 2205/0069

(57) ABSTRACT

A camera includes a movable cylinder movable relative to a stationary cylinder in an optical axis direction of a lens to function as a shutter, and a drive lever attached to the stationary cylinder to be rotatable about a lever shaft. The movable cylinder includes a shutter blade attached to a shutter base in a manner rotatable between a closing position to cover an exposure window in the shutter base and an opening position to uncover the exposure window, and a coil spring urging the shutter blade toward the closing position. The drive lever includes a drive engageable with a hook in the shutter blade in the movable cylinder. The camera includes a lever stopper that retains, against an urging force from a coil spring, the drive lever at a charge position at which the drive in the drive lever is engageable with the hook in the shutter blade.

### RELATED APPLICATIONS

The present application claims priority to Japanese Application Number 2022-082980, filed May 20, 2022, the disclosure of which is hereby incorporated by reference herein in its entirety.

### BACKGROUND

### Technical Field

The present invention relates to a camera, and particularly, to a camera including a movable cylinder that is movable in an optical axis direction.

### Description of the Background

A known camera includes a cylinder holding a lens that remains accommodated in a body when photographing is not performed and extendable in an optical axis direction when photographing is performed (refer to, for example, Patent Literature 1). Such a camera includes the cylinder movable in the optical axis direction relative to the body and is thus either structurally difficult to have a mechanical shutter attached to the cylinder for cooperative operation with the body, or structurally complicated with a mechanical shutter attached to the cylinder. Shutter assemblies with a simple structure attachable to such cylinders have been awaited.

### CITATION LIST

### Patent Literature

Patent Literature 1: Japanese Patent No. 5328249

### BRIEF SUMMARY

In response to the above issue, one or more aspects of the present invention are directed to a camera including a movable cylinder with a simple structure that is movable in an optical axis direction to function as a shutter.

A camera according to one aspect of the present invention includes a movable cylinder with a simple structure that is movable in an optical axis direction to function as a shutter. The camera includes a stationary cylinder, a movable cylinder holding at least one lens and being movable between a retracted position and an extended position relative to the stationary cylinder in an optical axis direction of the at least one lens, and a drive lever attached to the stationary cylinder in a manner rotatable about a first lever shaft. The movable cylinder includes a shutter base including an exposure window aligned with an optical axis of the at least one lens, a shutter blade attached to the shutter base in a manner rotatable between a closing position to cover the exposure window and an opening position to uncover the exposure window and including a hook to drive rotation, and a first urging member urging the shutter blade toward the closing position. The drive lever includes a drive engageable with the hook in the shutter blade in the movable cylinder at the extended position. The camera further includes a second urging member urging the drive lever in a direction in which the shutter blade rotates from the closing position toward the opening position, and a lever stopper that retains, against an urging force from the second urging member, the drive lever at a charge position at which the drive in the drive lever is engageable with the hook in the shutter blade.

### BRIEF DESCRIPTION OF DRAWINGS

FIG. 1 is a perspective view of a camera according to one embodiment of the present invention.

FIG. 2 is a perspective view of some of the components of the camera shown in FIG. 1 accommodated in an internal space defined by a front cover, a rear cover, and a top cover.

FIG. 3 is an exploded perspective view of the components shown in FIG. 2.

FIG. 4 is an exploded perspective view of a movable cylinder shown in FIG. 3.

FIG. 5A is a front view of a shutter blade shown in FIG. 4.

FIG. 5B is a bottom view of the shutter blade shown in FIG. 5A.

FIG. 6 is a front view of a shutter assembly with the shutter blade shown in FIG. 4 at a closing position.

FIG. 7 is a front view of the shutter assembly with the shutter blade shown in FIG. 4 at an opening position.

FIG. 8A is a plan view of a drive lever shown in FIG. 3.

FIG. 8B is a left side view of the drive lever shown in FIG. 8A.

FIG. 8C is a front view of the drive lever shown in FIG. 8A.

FIG. 8D is a schematic diagram of the drive lever shown in FIG. 8B attached to a stationary cylinder.

FIG. 9A is a plan view of a rotation restriction lever shown in FIG. 3.

FIG. 9B is a left side view of the rotation restriction lever shown in FIG. 9A.

FIG. 9C is a front view of the rotation restriction lever shown in FIG. 9A.

FIG. 9D is a schematic diagram of the rotation restriction lever shown in FIG. 9B attached to the stationary cylinder.

FIG. 10A is a left side view of a cam gear shown in FIG. 3.

FIG. 10B is a right side view of the cam gear shown in FIG. 10A.

FIG. 11A is a schematic left side view of the camera with the movable cylinder shown in FIG. 2 at a retracted position.

FIG. 11B is a schematic left side view of the camera with the movable cylinder shown in FIG. 2 at an extended position.

FIG. 12 is a schematic diagram describing the relationship between the drive lever and the shutter blade in the state shown in FIG. 11B.

FIG. 13A is a left side view of the camera in the process of driving the shutter blade in the state shown in FIG. 11B.

FIG. 13B is a left side view of the camera in the process following the process shown in FIG. 13A.

FIG. 13C is a left side view of the camera in the process following the process shown in FIG. 13B.

FIG. 13D is a left side view of the camera in the process following the process shown in FIG. 13C.

FIG. 13E is a left side view of the camera in the process following the process shown in FIG. 13D.

FIG. 14 is a schematic diagram describing the relationship between the drive lever and the shutter blade in the state shown in FIG. 13B.

FIG. 15 is a partial cross-sectional perspective view of the stationary cylinder shown in FIG. 3.

FIG. 16 is a cross-sectional view of the stationary cylinder shown in FIG. 3 and the shutter blade, showing their relationship.

### DETAILED DESCRIPTION

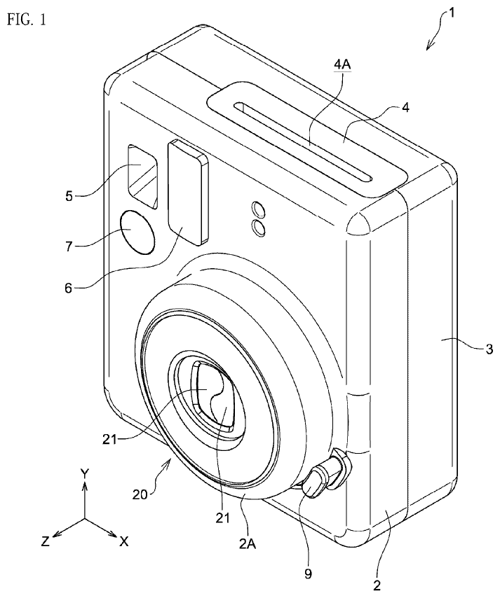

A camera according to one or more embodiments of the present invention will now be described in detail with reference to FIGS. 1 to 16. In FIGS. 1 to 16, like reference numerals denote like or corresponding components. Such components will not be described repeatedly. In FIGS. 1 to 16, the scale and dimensions of each component may be exaggerated, or one or more components may not be shown. Unless otherwise specified, the terms such as first and second will be used simply to distinguish the components and will not represent a specific order or sequence.

FIG. 1 is a perspective view of a camera 1 according to a first embodiment of the present invention. Although the camera 1 according to the present embodiment is a camera (instant camera) that uses a photographic film to be automatically developed after photographing, the present invention is also applicable to a camera other than such an instant camera. For ease of explanation in the present embodiment, the term front or frontward refers to the positive Z-direction in FIG. 1, and the term rear or rearward refers to the negative Z-direction in FIG. 1.

As shown in FIG. 1, the camera 1 includes a front cover 2, a rear cover 3 attached to the rear of the front cover 2, and a top cover 4 held between the front cover 2 and the rear cover 3. The front cover 2 includes a viewfinder 5. A flash window 6 is located adjacent to the viewfinder 5. A release button 7 is located in the negative Y-direction from the viewfinder 5. The top cover 4 has an ejection slit 4A elongated in X-direction, through which a developed photographic film is ejected after photographing.

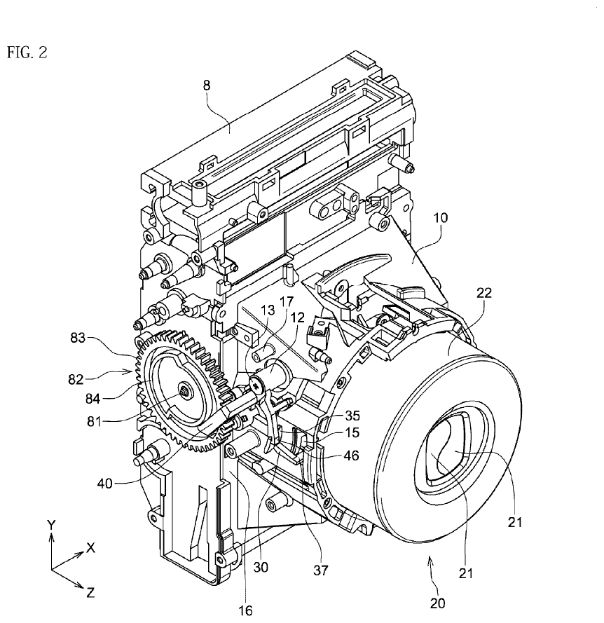

FIG. 2 is a perspective view of some of the components accommodated in an internal space defined by the front cover 2, the rear cover 3, and the top cover 4. As shown in FIG. 2, the camera 1 includes a substantially rectangular frame 8, a stationary cylinder 10 fastened to the frame 8, and a movable cylinder 20 located radially inward from the stationary cylinder 10. The movable cylinder 20 is accommodated in a cylindrical portion 2A of the front cover 2 (refer to FIG. 1) when photographing is not performed. In response to an operation button 9 (refer to FIG. 1) depressed by a user for photographing, the movable cylinder 20 is moved by an extension assembly (not shown) in the positive Z-direction relative to the stationary cylinder 10 to protrude (extend) from the cylindrical portion 2A of the front cover 2. The position of the movable cylinder 20 being accommodated in the cylindrical portion 2A of the front cover 2 is hereafter referred to as a retracted position. The position of the movable cylinder 20 protruding from the cylindrical portion 2A of the front cover 2 in the positive Z-direction is hereafter referred to as an extended position. In FIG. 2, the movable cylinder 20 is at the retracted position.

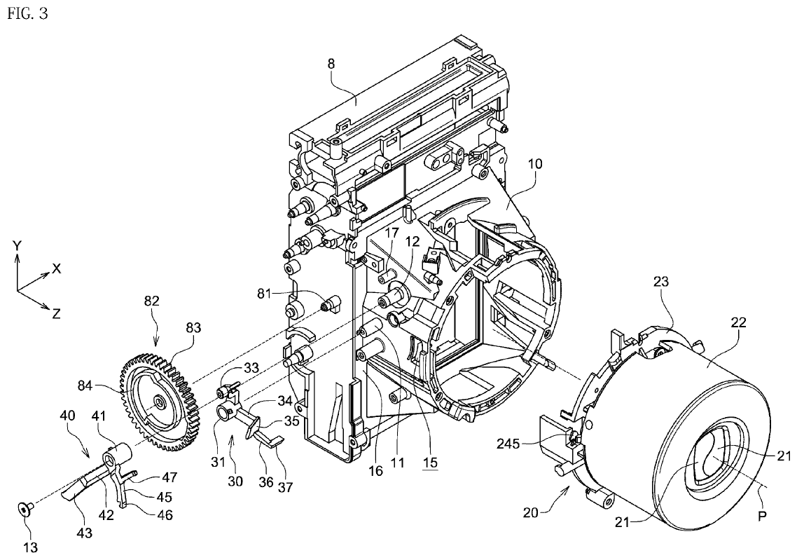

FIG. 3 is an exploded perspective view of the components shown in FIG. 2. As shown in FIG. 3, the camera 1 includes a cam gear 82, a drive lever 30, and a rotation restriction lever 40. The cam gear 82 is rotatably attached to a gear shaft 81 on the frame 8. The drive lever 30 is rotatably attached to a lever shaft 11 (first lever shaft) on the stationary cylinder 10. The rotation restriction lever 40 is rotatably attached to a lever shaft 12 (second lever shaft) on the stationary cylinder 10 with a screw 13.

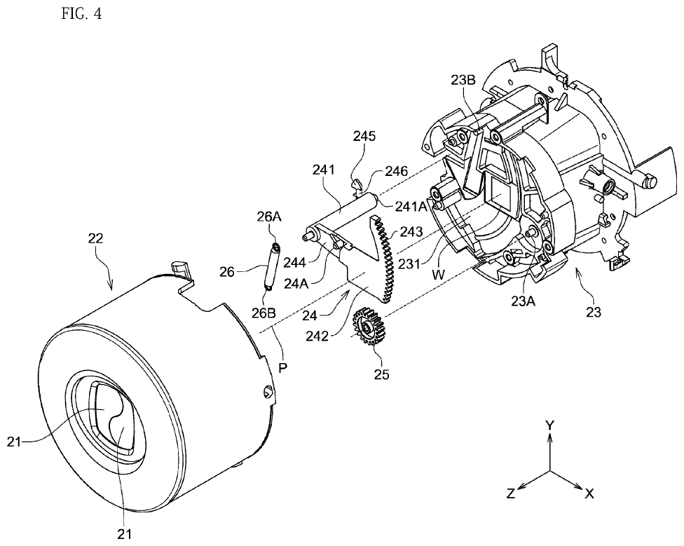

FIG. 4 is an exploded perspective view of the movable cylinder 20. As shown in FIG. 4, the movable cylinder 20 includes a cylinder body 22 holding one or more lenses (not shown) and barriers 21, a shutter base 23 behind the cylinder body 22, a shutter blade 24 attached to the shutter base 23, a governor gear 25 attached to a gear shaft 23A in the shutter base 23, and a coil spring 26 extending between the shutter base 23 and the shutter blade 24. The shutter base 23 includes a rectangular exposure window W. The exposure window W is aligned with an optical axis P of one or more lenses in the cylinder body 22.

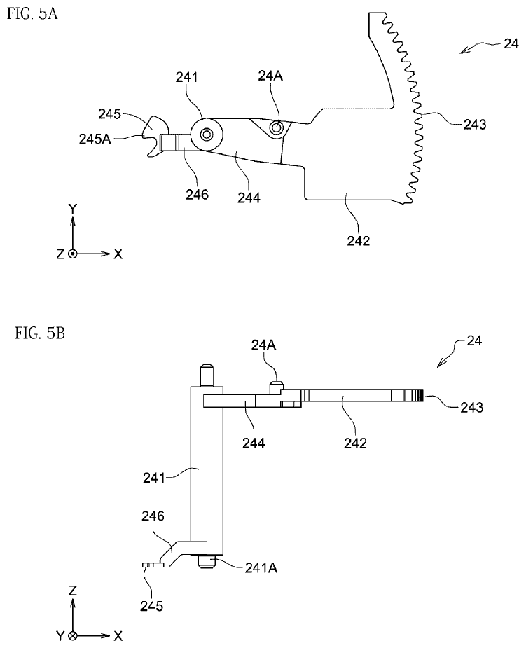

FIG. 5A is a front view of the shutter blade 24. FIG. 5B is a bottom view of the shutter blade 24. As shown in FIGS. 5A and 5B, the shutter blade 24 includes a rotational shaft 241, a light shield 242, a gear 243, an arm 244, a hook 245, and an arm 246. The rotational shaft 241 extends in Z-direction. The light shield 242 is a rectangular plate and can cover the exposure window W in the shutter base 23. The gear 243 is located radially outward from the light shield 242 and extends in a circumferential direction. The arm 244 connects the light shield 242 and the rotational shaft 241. The hook 245 drives the rotation of the shutter blade 24. The arm 246 connects the hook 245 and the rotational shaft 241. The arm 244 is located near the end of the rotational shaft 241 in the positive Z-direction. The arm 246 is located near the end of the rotational shaft 241 in the negative Z-direction. The rotational shaft 241 has, in the negative Z-direction, an end 241A received in a shaft hole (not shown) in the shutter base 23. The shutter blade 24 is thus attached to the shutter base 23 in a manner rotatable about the rotational shaft 241. The gear 243 in the shutter blade 24 meshes with the governor gear 25 on the shutter base 23. The governor gear 25 thus reduces the rotation of the shutter blade 24 about the rotational shaft 241.

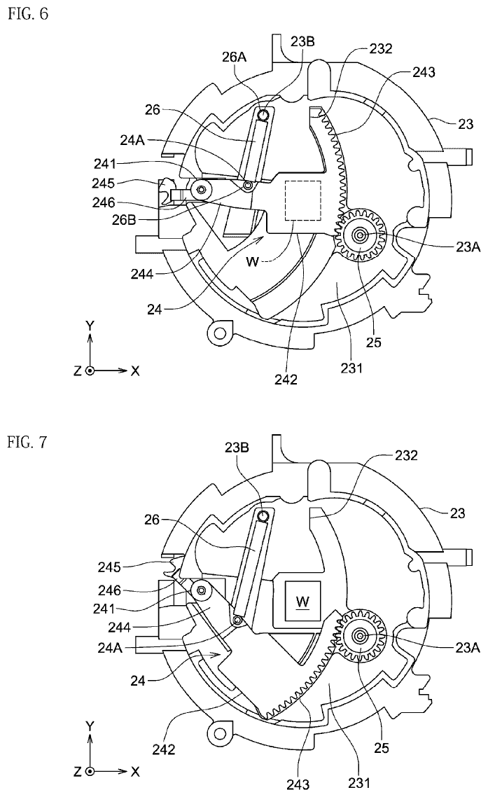

FIG. 6 is a front view of the shutter blade 24 with the movable cylinder 20 at the retracted position. As shown in FIG. 6, the coil spring 26 has one end 26A engaged with a pin 23B in the shutter base 23 and the other end 26B engaged with a pin 24A on the arm 244 in the shutter blade 24. The coil spring 26 being pulled extends between the pins 23B and 24A. Thus, under no external force on the shutter blade 24, the shutter blade 24 remains stationary with the shutter blade 24 rotated counterclockwise until an end of the gear 243 in the shutter blade 24 hits a step 232 on a stage 231 in the shutter base 23, as shown in FIG. 6. In this state, the light shield 242 covers the exposure window W in the shutter base 23. The position of the shutter blade 24 in this state is referred to as a closing position. As described above, the coil spring 26 in the present embodiment functions as an urging member (first urging member) that urges the shutter blade 24 toward the closing position.

Upon receiving a force on the hook 245 in the shutter blade 24 in response to the operation of the drive lever 30 (described later), the shutter blade 24 in the state shown in FIG. 6 rotates clockwise about the rotational shaft 241 as shown in FIG. 7. This causes the light shield 242 in the shutter blade 24 to retract from the exposure window W in the shutter base 23, thus uncovering the exposure window W. The position of the shutter blade 24 in this state is referred to as an opening position. Light through one or more lenses in the cylinder body 22 in the movable cylinder 20 is incident on a photographic film (not shown) contained in the frame 8 through the exposure window W to expose the photographic film. In response to the force applied from the drive lever 30 to the hook 245 in the shutter blade 24 being released, the shutter blade 24 in the state shown in FIG. 7 then rotates counterclockwise under an urging force from the coil spring 26 to return to the state shown in FIG. 6, causing the light shield 242 in the shutter blade 24 to cover the exposure window W in the shutter base 23 again. In this manner, the exposure window W is uncovered for a predetermined time for photographing.

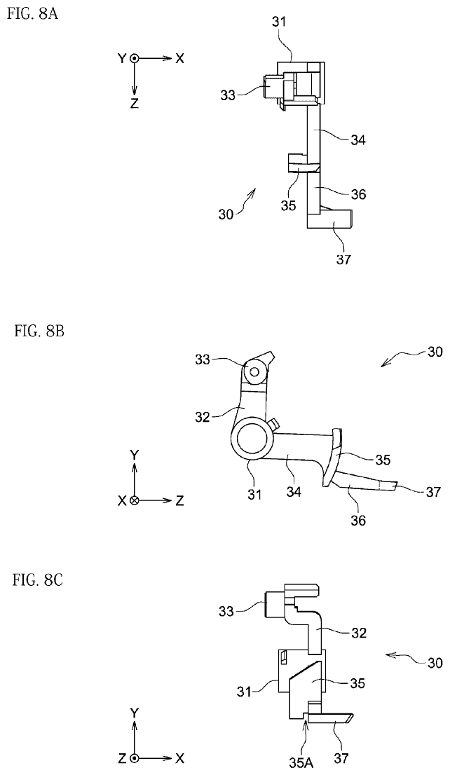

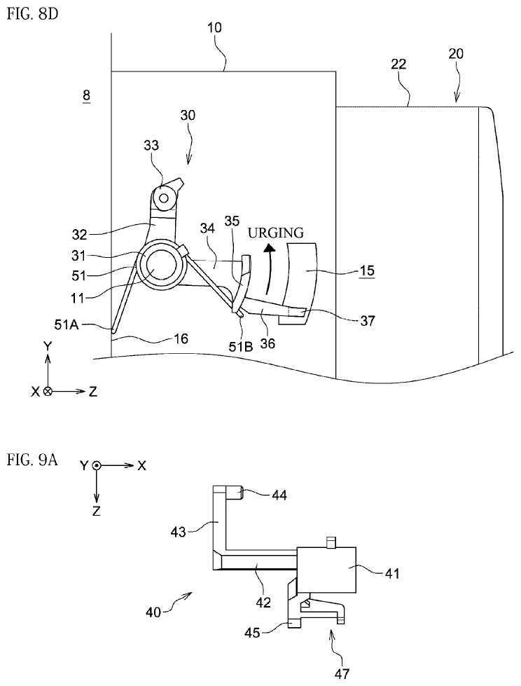

FIG. 8A is a plan view of the drive lever 30 shown in FIG. 3. FIG. 8B is a left side view of the drive lever 30. FIG. 8C is a front view of the drive lever 30. As shown in FIGS. 8A to 8C, the drive lever 30 includes a shaft 31, a first arm 32, a first follower 33, a second arm 34, an engagement member 35, a third arm 36, and a drive 37. The shaft 31 receives the lever shaft 11 on the stationary cylinder 10. The first arm 32 extends radially outward from the shaft 31. The first follower 33 is substantially cylindrical and extends from the end of the first arm 32 in the negative X-direction. The second arm 34 extends radially outward from the shaft 31 in a direction different from the direction in which the first arm 32 extends. The engagement member 35 is located at the end of the second arm 34 and extends along an arc centered on the shaft 31. The third arm 36 extends radially outward from the engagement member 35. The drive 37 extends from the end of the third arm 36 in the positive X-direction.

FIG. 8D is a schematic diagram of the drive lever 30 attached to the stationary cylinder 10. As shown in FIG. 8D, the drive lever 30 with the shaft 31 receiving the lever shaft 11 on the stationary cylinder 10 is rotatable about the lever shaft 11. A coil spring 51 surrounds the shaft 31 in the drive lever 30. The coil spring 51 includes one arm 51A engaged with a surface 16 of the frame 8 and the other arm 51B engaged with a cutout 35A in the engagement member 35 in the drive lever 30 (refer to FIG. 8C). The coil spring 51 surrounding the shaft 31 in the drive lever 30 has an opening angle between the arms 51A and 51B smaller than the free angle of the coil spring 51. The coil spring 51 thus functions as an urging member (second urging member) that urges the drive lever 30 counterclockwise as in FIG. 8D. An urging force from the coil spring 51 to urge the drive lever 30 is greater than the urging force from the coil spring 26 to urge the shutter blade 24.

As shown in FIGS. 8D and 2, the drive 37 in the drive lever 30 extends inside the stationary cylinder 10 through an opening 15 in the peripheral wall of the stationary cylinder 10. When the movable cylinder 20 is at the extended position, the hook 245 in the shutter blade 24 in the movable cylinder 20 is near the opening 15 in the stationary cylinder 10. The drive 37 in the drive lever 30 is engageable with the hook 245 in the shutter blade 24. This will be described in detail later.

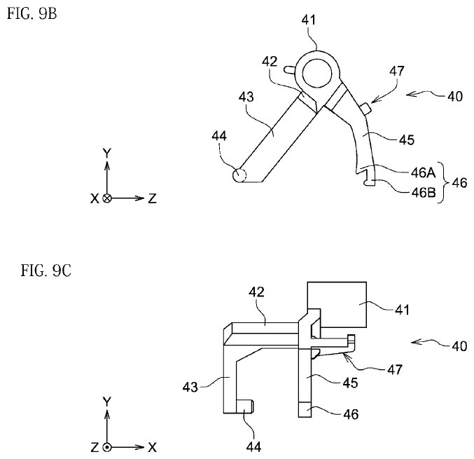

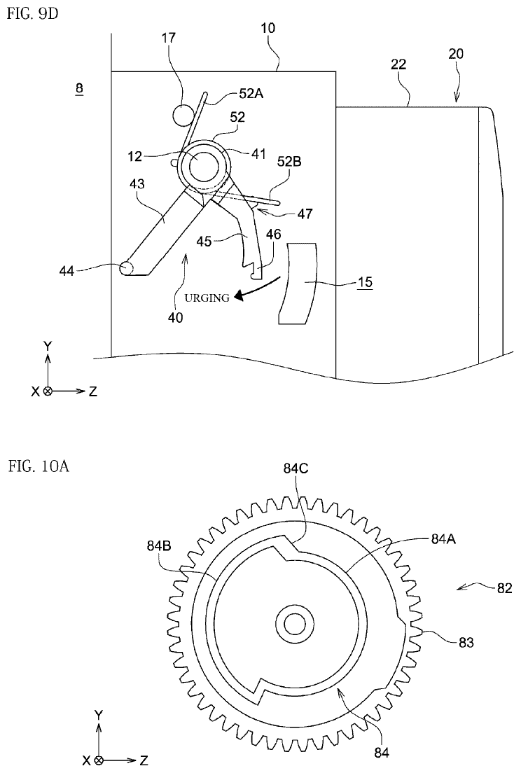

FIG. 9A is a plan view of the rotation restriction lever 40 shown in FIG. 3. FIG. 9B is a left side view of the rotation restriction lever 40. FIG. 9C is a front view of the rotation restriction lever 40. As shown in FIGS. 9A to 9C, the rotation restriction lever 40 includes a shaft 41, a first arm 42, a second arm 43, a second follower 44, a third arm 45, a lever stopper 46, and a spring receiver 47. The shaft 41 receives the lever shaft 12 on the stationary cylinder 10. The first arm 42 extends from the shaft 41 in the negative X-direction. The second arm 43 extends radially outward from the end of the first arm 42. The second follower 44 is substantially cylindrical and extends from the end of the second arm 43 in the positive X-direction. The third arm 45 extends radially outward from the shaft 41 in a direction different from the direction in which the second arm 43 extends. The lever stopper 46 is engageable with the engagement member 35 in the drive lever 30. The spring receiver 47 is in the middle of the third arm 45. The lever stopper 46 includes a base 46A located in the negative Z-direction and a hook 46B located in the positive Z-direction from the base 46A and extending in the negative Y-direction. The lever stopper 46 has a step between the base 46A and the hook 46B.

FIG. 9D is a schematic diagram of the rotation restriction lever 40 attached to the stationary cylinder 10. As shown in FIG. 9D, the rotation restriction lever 40 with the shaft 41 receiving the lever shaft 12 on the stationary cylinder 10 is rotatable about the lever shaft 12. A coil spring 52 surrounds the shaft 41 in the rotation restriction lever 40. The coil spring 52 includes one arm 52A engaged with a spring stopper 17 in the stationary cylinder 10 and the other arm 52B engaged with the spring receiver 47 in the rotation restriction lever 40. The coil spring 52 surrounding the shaft 41 in the rotation restriction lever 40 has an opening angle between the arms 52A and 52B smaller than the free angle of the coil spring 52. The coil spring 52 thus functions as an urging member that urges the rotation restriction lever 40 clockwise as in FIG. 9D.

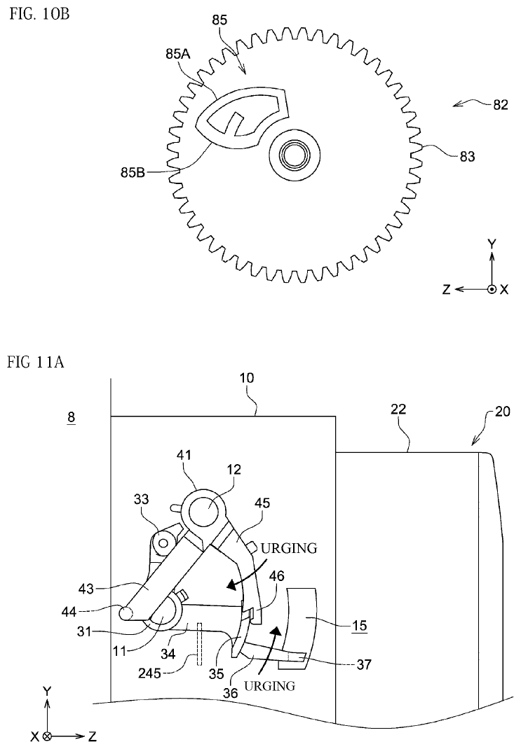

FIG. 10A is a left side view of the cam gear 82. FIG. 10B is a right side view of the cam gear 82. As shown in FIGS. 10A and 10B, the cam gear 82 includes a gear 83 on its outer circumference, an actuation cam 84 located radially inward from the gear 83, and a charge cam 85 located opposite to the actuation cam 84. The gear 83 is connected to an output shaft in a motor (not shown) with a gear assembly (not shown). The cam gear 82 thus rotates about the gear shaft 81 as the motor rotates.

The actuation cam 84 has a first arc surface 84A with a small diameter, a second arc surface 84B with a larger diameter than the first arc surface 84A, and an inclined surface 84C connecting the first arc surface 84A and the second arc surface 84B. The actuation cam 84 is used to control the operation of the rotation restriction lever 40 described above and comes in contact with the second follower 44 in the rotation restriction lever 40 described above.

The charge cam 85 has a first arc surface 85A with a large diameter and a second arc surface 85B with a smaller diameter than the first arc surface 85A. The charge cam 85 is used to move the drive lever 30 described above to the position (charge position) shown in FIG. 8D and comes in contact with the first follower 33 in the drive lever 30.

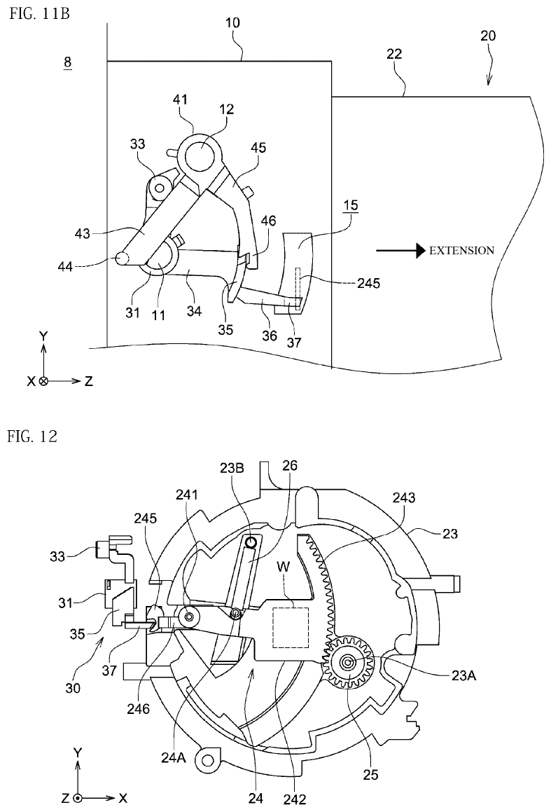

The operation of the shutter blade 24 in the camera 1 with the above structure will now be described in detail. FIG. 11A is a schematic left side view of the camera with the movable cylinder 20 at the retracted position. As shown in FIG. 11A, with the movable cylinder 20 at the retracted position, the lever stopper 46 in the rotation restriction lever 40 is engaged with the engagement member 35 in the drive lever 30. The drive lever 30 is retained at the position (charge position) shown in FIG. 11A under an urging force from the coil spring 52 (refer to FIG. 9D) acting on the rotation restriction lever 40.

In this state, the shutter blade 24 in the movable cylinder 20 receives the urging force from the coil spring 26 alone and is at the closing position shown in FIG. 6. The hook 245 in the shutter blade 24 in this state is located in the negative Z-direction from the opening 15 in the stationary cylinder 10 as shown in FIG. 11A.

When the user depresses the operation button 9 (refer to FIG. 1) in this state, the movable cylinder 20 is moved by the extension assembly (not shown) in the positive Z-direction relative to the stationary cylinder 10 and extends from the cylindrical portion 2A of the front cover 2 as described above. As the movable cylinder 20 extends, the hook 245 in the shutter blade 24 in the movable cylinder 20 moves to a position radially inward from the opening 15 in the stationary cylinder 10 as shown in FIG. 11B.

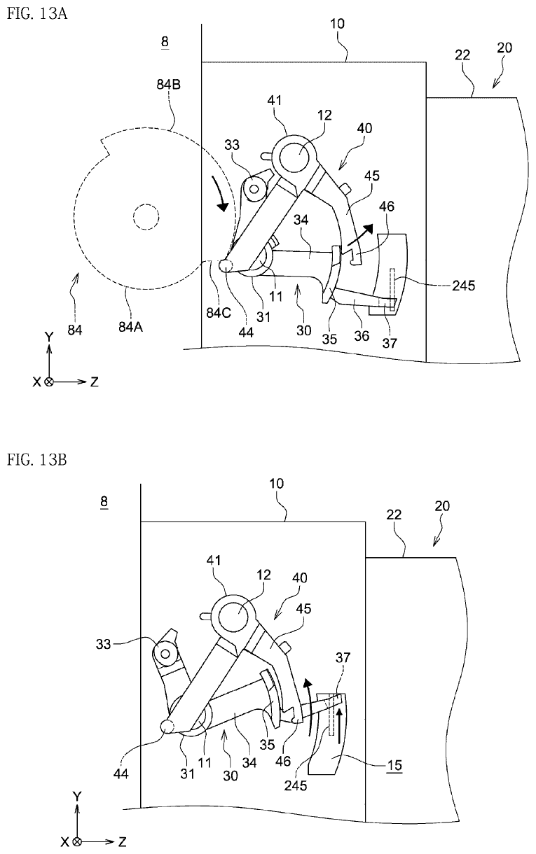

FIG. 12 is a schematic diagram describing the relationship between the drive lever 30 and the shutter blade 24 in the state shown in FIG. 11B. As shown in FIG. 12, with the movable cylinder 20 at the extended position, the drive 37 in the drive lever 30 is inside the hook 245 in the shutter blade 24.

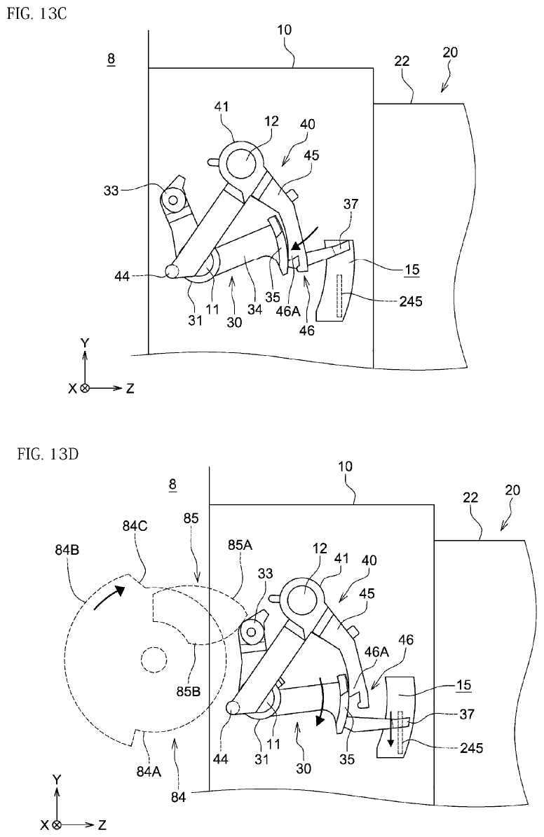

When the user depresses the release button 7 in this state, the motor is driven to rotate the cam gear 82 clockwise, causing the inclined surface 84C of the actuation cam 84 in the cam gear 82 to come in contact with the second follower 44 in the rotation restriction lever 40 as shown in FIG. 13A. This causes the rotation restriction lever 40 to rotate counterclockwise about the lever shaft 12. The lever stopper 46 in the rotation restriction lever 40 thus disengages from the engagement member 35 in the drive lever 30.

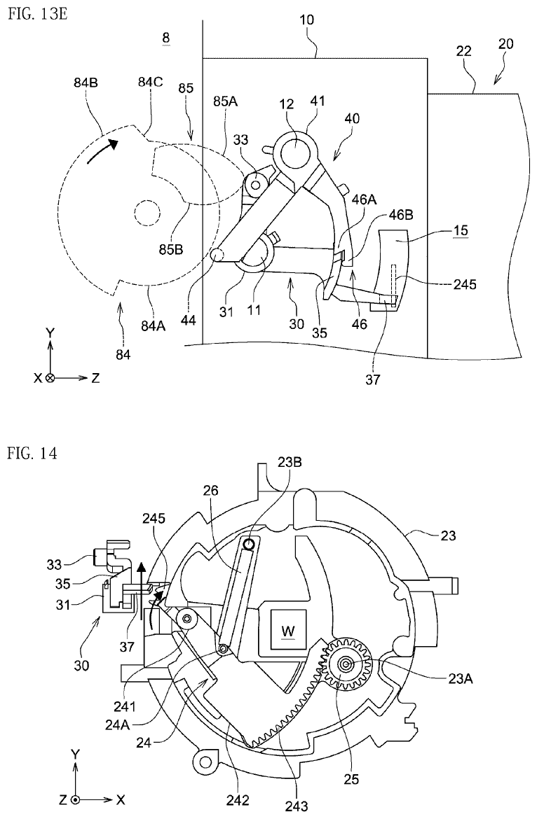

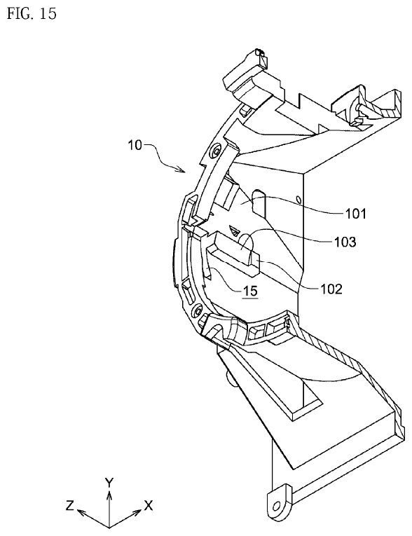

This causes the drive lever 30 to rotate counterclockwise under the urging force from the coil spring 51 (refer to FIG. 8D), moving the drive 37 in the drive lever 30 in the positive Y-direction in the opening 15 in the stationary cylinder 10, as shown in FIG. 13B. As described above, the drive 37 in the drive lever 30 is inside the hook 245 in the shutter blade 24. The hook 245 in the shutter blade 24 thus engages with the drive 37 in the drive lever 30 and rotates clockwise about the rotational shaft 241 as the drive 37 moves in the positive Y-direction as shown in FIG. 14. This causes the light shield 242 in the shutter blade 24 to rotate clockwise, thus uncovering the exposure window W.

Although the drive 37 in the drive lever 30 stops upon hitting the edge of the opening 15 in the stationary cylinder 10, the drive 37 in the drive lever 30 is disengaged from the hook 245 in the shutter blade 24 while moving in the opening 15, as shown in FIG. 14. Thus, once the drive lever 30 stops, the shutter blade 24 receives the urging force from the coil spring 26, starts rotating counterclockwise, and returns to the state shown in FIG. 6. With the operation described above, the exposure window W is uncovered for a predetermined time for photographing with the camera 1.

As described above, the drive lever 30 retained at the charge position by the lever stopper 46 in the rotation restriction lever 40 is released to allow the drive 37 in the drive lever 30 and the hook 245 in the shutter blade 24 to be engaged with each other. This causes the shutter blade 24 urged by the coil spring 26 toward the closing position to rotate toward the opening position, thus uncovering the exposure window W. In response to the drive 37 in the drive lever 30 being disengaged from the hook 245 in the shutter blade 24, the shutter blade 24 then returns to the closing position under the urging force from the coil spring 26, thus covering the exposure window W. In the present embodiment described above, the exposure window W can be uncovered for a predetermined time with a simple structure for photographing.

After photographing, the motor is driven further to rotate the cam gear 82. The rotation restriction lever 40 thus receives the urging force acting from the coil spring 52 (refer to FIG. 9D) and rotates clockwise as shown in FIG. 13C. However, the rotation restriction lever 40 is restricted from rotating once the base 46A in the lever stopper 46 in the rotation restriction lever 40 comes in contact with the surface (cylindrical surface) of the engagement member 35 in the drive lever 30.

As the motor is driven further, the second arc surface 85B of the charge cam 85 in the cam gear 82 comes in contact with the first follower 33 in the drive lever 30, thus causing the drive lever 30 to rotate clockwise about the lever shaft 11, as shown in FIG. 13D. In this state, the base 46A in the lever stopper 46 in the rotation restriction lever 40 slides on the surface of the engagement member 35 in the drive lever 30. The clockwise rotation of the drive lever 30 moves the drive 37 in the drive lever 30 in the negative Y-direction in the opening 15 in the stationary cylinder 10.

As the motor is driven further, the base 46A in the lever stopper 46 in the rotation restriction lever 40 separates from the surface of the engagement member 35 in the drive lever 30. The hook 46B in the lever stopper 46 comes in contact with and slides on the surface of the engagement member 35 in the drive lever 30, as shown in FIG. 13E.

As the motor is driven further, the first follower 33 in the drive lever 30 comes in contact with the first arc surface 85A of the charge cam 85. This causes the drive lever 30 to rotate counterclockwise, thus firmly engaging the engagement member 35 in the drive lever 30 with the lever stopper 46 in the rotation restriction lever 40, as shown in FIG. 11B.

As described above, the charge cam 85 in the cam gear 82 functions as a cam (first cam) that comes in contact with the first follower 33 in the drive lever 30 and causes the engagement member 35 in the drive lever 30 to rotate to the position at which the engagement member 35 is engageable with the lever stopper 46 in the rotation restriction lever 40. The actuation cam 84 in the cam gear 82 functions as a cam (second cam) that comes in contact with the second follower 44 in the rotation restriction lever 40 and causes the lever stopper 46 to rotate from the position at which the lever stopper 46 is engaged with the drive lever 30 to the position at which the lever stopper 46 is disengaged from the drive lever 30.

The drive 37 in the drive lever 30 hits the hook 245 in the shutter blade 24 while moving in the negative Y-direction. The drive 37 and the hook 245 hit each other on their inclined surfaces to bend each other. This allows the drive 37 to move over an edge 245A of the hook 245 (FIG. 5A) and move inside the hook 245.

As described above, the shutter blade 24 in the movable cylinder 20 at the closing position covers the exposure window W in the shutter base 23 with the light shield 242, thus preventing the photographic film in the frame 8 from being exposed accidentally. However, when the movable cylinder 20 receives a shock in response to, for example, the camera 1 being dropped, the shutter blade 24 may move against the urging force from the coil spring 26, uncovering the exposure window W accidentally. In this case, external light may be incident on the photographic film, which may then be wasted.

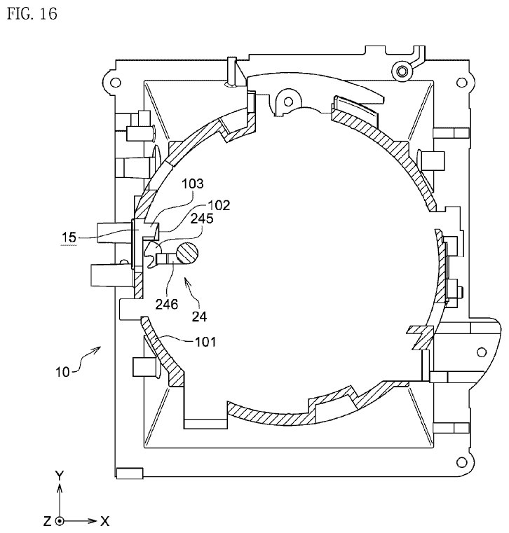

The stationary cylinder 10 in the present embodiment thus includes shutter stoppers 102 and 103 protruding radially inward from a cylindrical peripheral wall 101 as shown in FIG. 15. FIG. 16 is a cross-sectional view of the stationary cylinder 10 and the shutter blade 24 in the movable cylinder 20 at the retracted position, showing the relationship between the stationary cylinder 10 and the shutter blade 24. The shutter blade 24 rotates in an opening direction from the closing position shown in FIG. 6 to the opening position shown in FIG. 7. As shown in FIG. 16, the shutter stopper (first stopper) 102 is, in the opening direction, adjacent to the hook 245 in the shutter blade 24 in the movable cylinder 20 at the retracted position. The shutter stopper (second stopper) 103 extends continuously from the shutter stopper 102 to the opening 15 in the positive Z-direction of the shutter stopper 102. Although the shutter stopper 103 has a smaller radial thickness than the shutter stopper 102 as appropriate for the outer diameter of the movable cylinder 20 in the present embodiment, the shutter stopper 103 may have the same radial thickness as the shutter stopper 102.

In this structure, when, for example, the movable cylinder 20 receives a shock at the retracted position, the shutter blade 24 with the hook 245 engaged with the shutter stopper 102 is restricted from moving in the opening direction. This prevents the shutter blade 24 from moving accidentally and uncovering the exposure window W. When, for example, the movable cylinder 20 receives a shock while moving from the retracted position to the extended position, the shutter blade 24 with the hook 245 engaged with the shutter stopper 103 is restricted from moving in the opening direction. This prevents the shutter blade 24 from moving accidentally and uncovering the exposure window W. The barriers 21 in the movable cylinder 20 in the present embodiment may thus be eliminated.

As described above, a camera according to one aspect of the present invention allows a movable cylinder movable in an optical axis direction to function as a shutter with a simple structure. More specifically, the camera according to one or more embodiments of the present invention may have the structures described below.

### First Structure

The camera includes a stationary cylinder, a movable cylinder holding at least one lens and being movable between a retracted position and an extended position relative to the stationary cylinder in an optical axis direction of the at least one lens, and a drive lever attached to the stationary cylinder in a manner rotatable about a first lever shaft. The movable cylinder includes a shutter base including an exposure window aligned with an optical axis of the at least one lens, a shutter blade attached to the shutter base in a manner rotatable between a closing position to cover the exposure window and an opening position to uncover the exposure window and including a hook to drive rotation, and a first urging member urging the shutter blade toward the closing position. The drive lever includes a drive engageable with the hook in the shutter blade in the movable cylinder at the extended position. The camera further includes a second urging member urging the drive lever in a direction in which the shutter blade rotates from the closing position toward the opening position, and a lever stopper that retains, against an urging force from the second urging member, the drive lever at a charge position at which the drive in the drive lever is engageable with the hook in the shutter blade.

In this structure, the drive lever retained at the charge position by the lever stopper is released to allow the drive in the drive lever and the hook in the shutter blade to be engaged with each other. This causes the shutter blade urged by the first urging member toward the closing position to rotate toward the opening position, thus uncovering the exposure window. In response to the drive in the drive lever being disengaged from the hook in the shutter blade, the shutter blade then returns to the closing position under an urging force from the first urging member, thus covering the exposure window W. In the structure according to one or more embodiments of the present disclosure, as described above, the exposure window can be uncovered for a predetermined time with a simple structure for photographing.

### Second Structure

In the first structure, the stationary cylinder may include a first shutter stopper engageable with the hook in the shutter blade in the movable cylinder at the retracted position to restrict the shutter blade from moving from the closing position toward the opening position.

### Third Structure

In the second structure, the first shutter stopper in the stationary cylinder may protrude radially inward from a peripheral wall of the stationary cylinder. In this structure, when, for example, the movable cylinder receives a shock at the retracted position, the shutter blade with the hook engaged with the first shutter stopper is restricted from moving from the closing position to the opening position. This prevents the shutter blade from moving accidentally and uncovering the exposure window.

### Fourth Structure

In any one of the first to third structures, the stationary cylinder may include a second shutter stopper engageable with the hook in the shutter blade in the movable cylinder moving from the retracted position to the extended position to restrict the shutter blade from moving from the closing position toward the opening position.

### Fifth Structure

In the fourth structure, the second shutter stopper in the stationary cylinder may protrude radially inward from a peripheral wall of the stationary cylinder. In this structure, when, for example, the movable cylinder receives a shock while moving from the retracted position to the extended position, the shutter blade with the hook engaged with the second shutter stopper is restricted from moving from the closing position to the opening position. This prevents the shutter blade from moving accidentally and uncovering the exposure window.

### Sixth Structure

In any one of the first to fifth structures, the drive lever may further include an engagement member engageable with the lever stopper.

### Seventh Structure

In the sixth structure, the drive lever may further include a first follower located radially outward from the first lever shaft. In this case, the camera may further include a first cam that comes in contact with the first follower in the drive lever and causes the engagement member in the drive lever to rotate to a position at which the engagement member is engageable with the lever stopper.

### Eighth Structure

In any one of the first to seventh structures, the camera may further include a rotation restriction lever attached to the stationary cylinder in a manner rotatable about a second lever shaft. The rotation restriction lever may include the lever stopper.

### Ninth Structure

In the eighth structure, the rotation restriction lever may further include a second follower located radially outward from the second lever shaft. In this case, the camera may further include a second cam that comes in contact with the second follower in the rotation restriction lever and causes the lever stopper to rotate from a position at which the lever stopper is engaged with the drive lever to a position at which the lever stopper is disengaged from the drive lever.

Although the embodiments of the present invention have been described above, the present invention is not limited to the above embodiments and may be modified variously within the scope of its technical idea.

What is claimed is:

1. A camera, comprising:
a stationary cylinder;
a movable cylinder holding at least one lens, the movable cylinder being movable between a retracted position and an extended position relative to the stationary cylinder in an optical axis direction of the at least one lens, the movable cylinder including
a shutter base including an exposure window aligned with an optical axis of the at least one lens,
a shutter blade attached to the shutter base in a manner rotatable between a closing position to cover the exposure window and an opening position to uncover the exposure window, the shutter blade including a hook to drive rotation, and
a first urging member urging the shutter blade toward the closing position;
a drive lever attached to the stationary cylinder in a manner rotatable about a first lever shaft, the drive lever including a drive engageable with the hook in the shutter blade in the movable cylinder at the extended position;
a second urging member urging the drive lever in a direction in which the shutter blade rotates from the closing position toward the opening position; and
a lever stopper configured to retain, against an urging force from the second urging member, the drive lever at a charge position at which the drive in the drive lever is engageable with the hook in the shutter blade.

2. The camera according to claim 1, wherein
the stationary cylinder includes a first shutter stopper engageable with the hook in the shutter blade in the movable cylinder at the retracted position to restrict the shutter blade from moving from the closing position toward the opening position.

3. The camera according to claim 2, wherein
the first shutter stopper in the stationary cylinder protrudes radially inward from a peripheral wall of the stationary cylinder.

4. The camera according to claim 1, wherein
the stationary cylinder includes a second shutter stopper engageable with the hook in the shutter blade in the movable cylinder moving from the retracted position to the extended position to restrict the shutter blade from moving from the closing position toward the opening position.

5. The camera according to claim 4, wherein
the second shutter stopper in the stationary cylinder protrudes radially inward from a peripheral wall of the stationary cylinder.

6. The camera according to claim 1, wherein
the drive lever further includes an engagement member engageable with the lever stopper.

7. The camera according to claim 6, wherein
the drive lever further includes a first follower located radially outward from the first lever shaft, and
the camera further comprises a first cam configured to come in contact with the first follower in the drive lever and cause the engagement member in the drive lever to rotate to a position at which the engagement member is engageable with the lever stopper.

8. The camera according to claim 1, further comprising:
a rotation restriction lever attached to the stationary cylinder in a manner rotatable about a second lever shaft, the rotation restriction lever including the lever stopper.

9. The camera according to claim 8, wherein
the rotation restriction lever further includes a second follower located radially outward from the second lever shaft, and
the camera further comprises a second cam configured to come in contact with the second follower in the rotation restriction lever and cause the lever stopper to rotate from a position at which the lever stopper is engaged with the drive lever to a position at which the lever stopper is disengaged from the drive lever.
